(19) United States
(12) Patent Application Publication
(10) Pub. No.: US 2014/0283787 A1
(43) Pub. Date: Sep. 25, 2014

(54) System to Lower fuel viscosity prior to fuel combustion

(71) Applicant: Joseph M. MCANDREWS, New York City, NY (US)

(72) Inventor: Joseph M. MCANDREWS, New York City, NY (US)

(21) Appl. No.: 14/220,055

(22) Filed: Mar. 19, 2014

Related U.S. Application Data
(60) Provisional application No. 61/803,341, filed on Mar. 19, 2013.

(51) Int. Cl. F02M 31/16

(52) U.S. Cl. CPC F02M 31/16
USPC 123/445

(57) ABSTRACT

A system to lower fuel viscosity prior to fuel combustion includes at least one fuel heating system and a pressure pump system. The pressure pump system and the at least one fuel heating system are in fluid communication with the a fuel injection system to accommodate for the fuel circulation, where the at least one fuel heating system heats up the ambient temperature fuel from the fuel injection system prior to combustion. A plurality of valves that is electronically connected with an ECU functions within the pressure pump system, the at least one fuel heating system, and the fuel injection system for the optimized performance of the pressure pump system and the at least one fuel heating system.

The current application claims a priority to the U.S. Provisional Patent application Ser. No. 61/803,341 filed on Mar. 19, 2013.

### FIELD OF THE INVENTION

The present invention relates generally to an apparatus for an internal combustion engine. More specifically, the present invention is a system for lowering a fuel viscosity prior to fuel combustion.

### BACKGROUND OF THE INVENTION

Internal combustion engine has improved over time because of engineering advances and adaptation of variety of applications. Many advances have been made to the internal combustion engine to increase the fuel efficiency and to the reduce pollutant products. Engineers have implemented many different features, such as modified fuel supply system, different engine configurations, zone combustion, and different exhaust systems, so that the efficiency of the internal combustion engine can be improved. For many years auto makers have tried many ways to heat fuel prior to fuel combustion so that the engine efficiency can be improved. However, many different fuel heating systems have failed and have not further developed commercially due to many different safety factors and reliability factors. Most of the existing fuel heating systems failed due to the fact they are not able to control and adequately confine the heated fuel with a high safety and reliability factor.

It is therefore an object of the present invention to introduce a system to safely and effectively lower fuel viscosity prior to fuel combustion. The present invention supplies pressurized and heated fuel into the combustion chamber so that the combustion process can be fast and clean. As a result, the engine is able to decrease the amount of fuel needed to propel a vehicle while increasing the efficiency of the internal combustion engine.

### BRIEF DESCRIPTION OF THE DRAWINGS

FIG. 1 is an overall process of the single fuel heating system within the fuel injection system of the engine.

FIG. 2 is an overall process of the single fuel heating system and the pressure pump system within the fuel injection system of the engine.

FIG. 3 is an isolation process of the single fuel heating system and the pressure pump system from the fuel injection system of the engine.

FIG. 4 is an overall process of the multiple fuel heating systems within the fuel injection system of the engine.

FIG. 5 is an overall process of the multiple fuel heating systems and the pressure pump system within the fuel injection system of the engine.

FIG. 6 is an isolation process of the multiple fuel heating systems and the pressure pump system from the fuel injection system of the engine.

FIG. 7 is a basic illustration showing the components of the fuel injection system

FIG. 8 is a basic illustration showing the electronically connected components of the present invention along with the ECU.

FIG. 9 is an illustration showing the basic configuration of the pressure pump system.

FIG. 10 is an illustration showing the basic configuration of the fuel heating system of the present invention, wherein the plurality of cooling fins is shown within the cooling line.

FIG. 11 is an illustration showing the basic configuration of the fuel heating system of the present invention, wherein the cooling line is adjacent to the radiator.

FIG. 12 is an illustration showing the basic configuration of the multiple fuel heating systems and the pressure pump system.

FIG. 13 is a basic illustration of the present invention within the inline four-cylinder engine.

FIG. 14 is a basic illustration of the present invention within the inline six-cylinder engine.

FIG. 15 is a basic illustration of the present invention within the V6-cylinder engine.

FIG. 16 is a basic illustration of the present invention within the V8-cylinder engine.

### DETAIL DESCRIPTIONS OF THE INVENTION

All illustrations of the drawings are for the purpose of describing selected versions of the present invention and are not intended to limit the scope of the present invention.

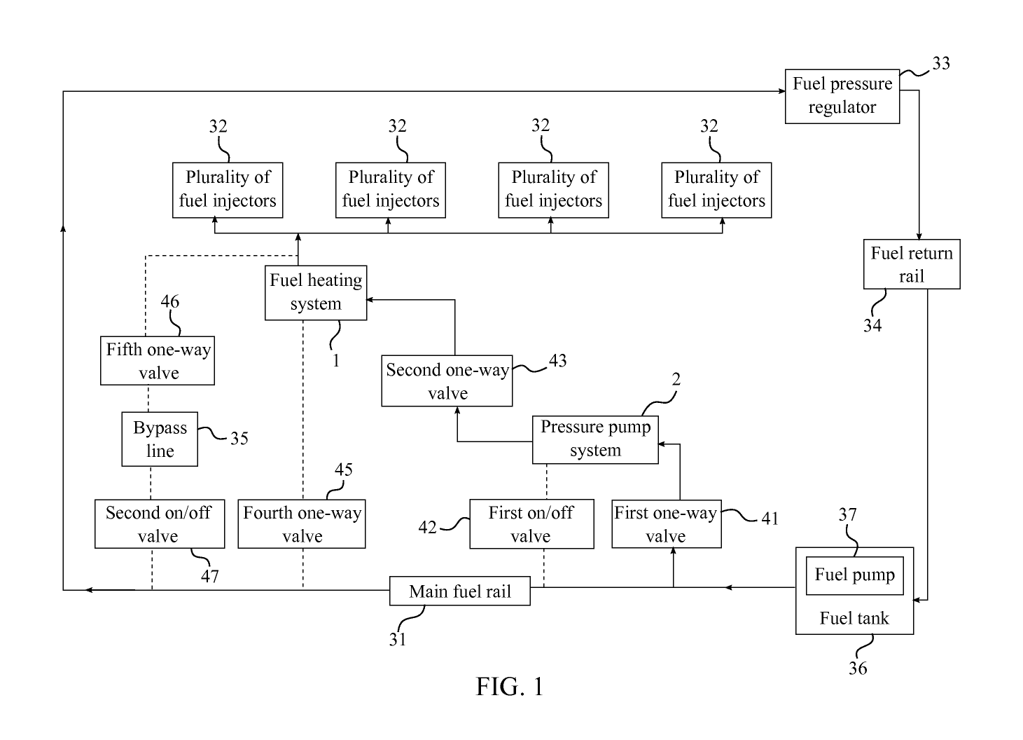

In reference to FIG. 1-FIG. 6, the present invention is a system to lower fuel viscosity by thermal means prior to fuel combustion, where the present invention comprises at least one fuel heating system 1, a pressure pump system 2, a plurality of valves 4, a first pressure and temperature sensor 5, and a second pressure and temperature sensor 6. The at least one fuel heating system 1 and the pressure pump system 2 function together with a fuel injection system 3 so that the ambient temperature fuel can be heated prior to combustion through the present invention. The present invention can be retrofitted into the existing fuel injection systems 3 or can be manufactured into the fuel injection systems 3 during the production phase. In its general configuration, the pressure pump system 2 is connected to a main fuel rail 31 of the fuel injection system 3 in such way that the pressure pump system 2 is in parallel fluid communication with the main fuel rail 31. The at least one fuel heating system 1 is connected to the pressure pump system 2, where the at least one fuel heating system 1 is in serial fluid communication with the pressure pump system 2. The pressure pump system 2 of the present invention supplies ambient temperature fuel from a fuel tank 36 of the fuel injection system 3 to the at least one fuel heating system 1 so that the at least one fuel heating system 1 is able to heat up the ambient temperature fuel. A plurality of fuel injectors 32 of the fuel injection system 3 is in serial fluid communication with the at least one fuel heating system 1 so that the heated fuel from the present invention is able to spray into the combustion chambers through the plurality of fuel injectors 32. The at least one fuel heating system 1 is also in parallel fluid communication with the main fuel rail 31 through a bypass line 35 of the fuel injection system 3. The bypass line 35, via a fifth one-way valve 46 of the plurality of valves 4, allows the ambient temperature fuel to spray into the combustion chambers through the plurality of fuel injectors 32 if the present invention is deactivated or isolated due to any circumstances.

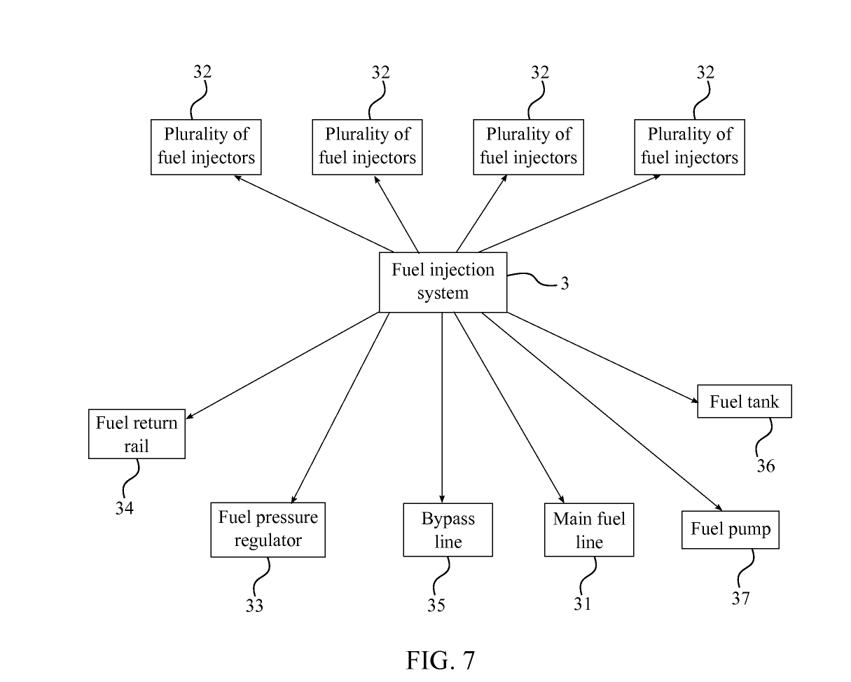

In reference to FIG. 1-FIG. 8, the fuel injection system further comprises a fuel pressure regulator 33, a fuel return rail 34, and a fuel pump 37. The main fuel rail 31 is in fluid communication with the fuel tank 36 through the fuel pump 37 as the fuel pump 37 filters and pumps ambient temperature fuel to the main fuel rail 31. The main fuel rail 31 is in serial fluid communication with the fuel return rail 34 through the fuel pressure regulator 33 as the fuel return rail 34 is in fluid communication with the fuel tank 36. The fuel pressure regulator 33 is electronically connected with an engine control unit (ECU) 9 through a plurality of smart sensors 10 and a controller-area network (CAN) bus 8 so that the ECU 9 is able to adjust the pressure within the main fuel rail 31 with respect to specification of the present invention. The plurality of fuel injectors 32 is also electronically connected with the ECU 9 through the plurality of smart sensors 10 and the CAN bus 8 in such way that the ECU 9 is able to individually control each of the plurality of fuel injectors 32 according to the present invention and the engine specifications.

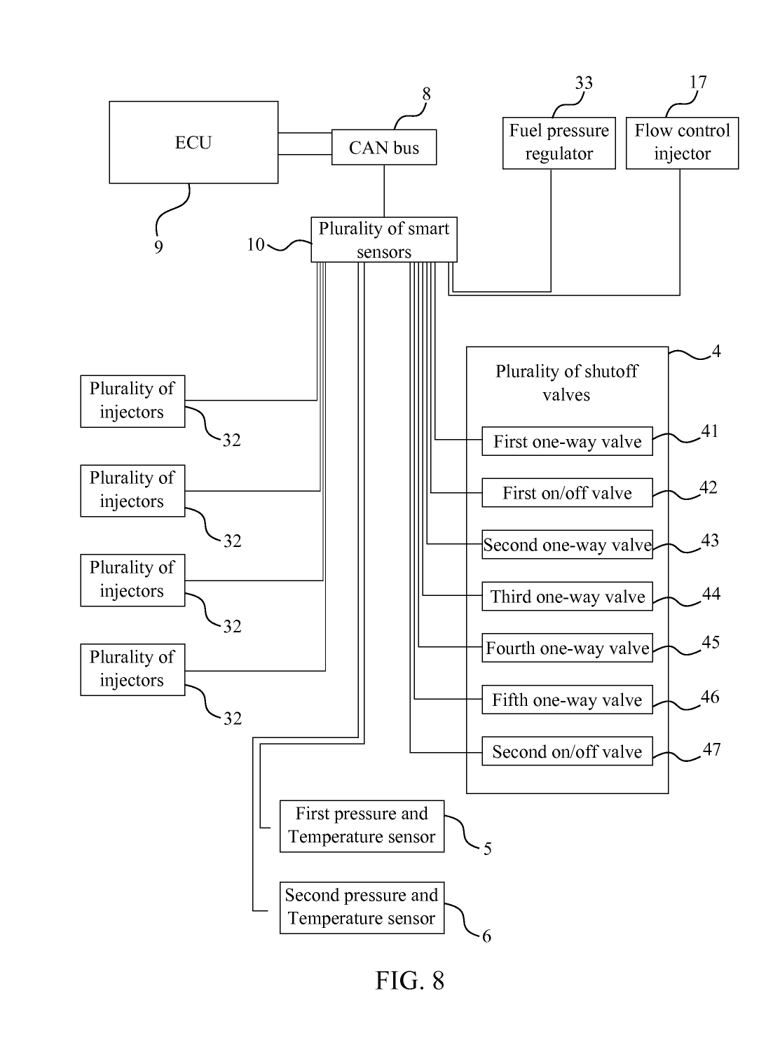

In reference to FIG. 8, the plurality of valves 4 comprises a first one-way valve 41, a first on/off valve 42, a second one-way valve 43, a third one-way valve 44, a fourth one-way valve 45, the fifth one-way valve 46, and a second on/off valve 47. The plurality of valves 4 functions and is positioned in relation to the present invention so that the present invention is able to efficiently function according to the correct specifications and control the direction of fuel flow. The plurality of valves 4 is electronically connected with the ECU 9 through the plurality of smart sensors 10 and the CAN bus 8 so that the ECU 9 is able to individually control each of the plurality of valves 4.

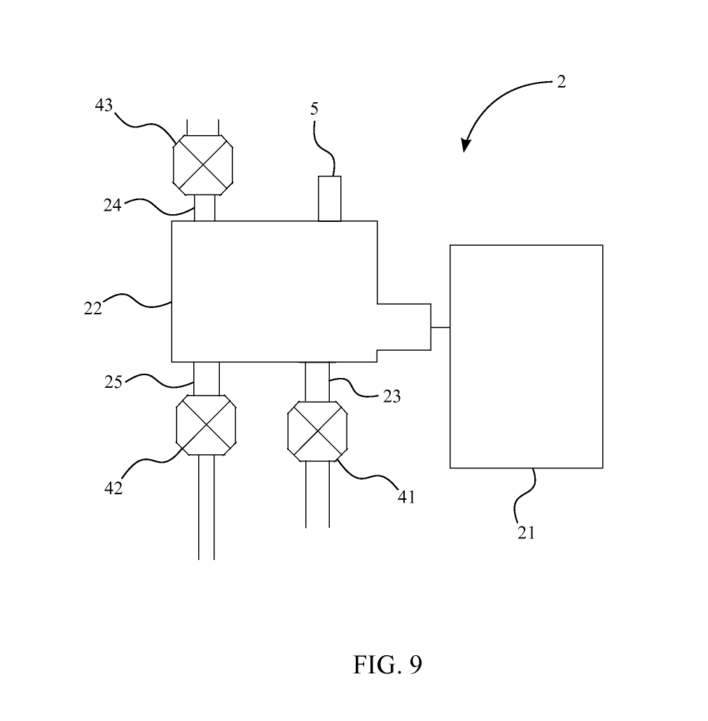

In reference to FIG. 9, the pressure pump system 2 comprises a cam-driven pump 21 and a fuel reservoir 22, where the cam-driven pump 21 is in fluid communication with the fuel reservoir 22. The fuel reservoir 22 comprises a fuel inlet 23, a fuel outlet 24, and a pressure-regulating outlet 25. The fuel inlet 23, the fuel outlet 24, and the pressure-regulating outlet 25 are in fluid communication with each other through the fuel reservoir 22 in such way that the fuel inlet 23, the fuel outlet 24, and the pressure-regulating outlet 25 extend from the fuel reservoir 22. More specifically, the fuel inlet 23 is in serial fluid communication with the main fuel rail 31 through the first one-way valve 41 as the first one-way valve 41 is positioned in between the fuel inlet 23 and the main fuel rail 31. The pressure-regulating outlet 25 is in serial fluid communication with the main fuel rail 31 through the first on/off valve 42 as the first on/off valve 42 is positioned in between the pressure-regulating outlet 25 and the main fuel rail 31. The fuel outlet 24 is in serial fluid communication with the at least one fuel heating system 1 through the second one-way valve 43 as the second one-way valve 43 is positioned in between the fuel outlet 24 and the at least one fuel heating system 1. The first pressure and temperature sensor 5 is positioned on the fuel reservoir 22, where the first pressure and temperature sensor 5 is electronically connected with the ECU 9 through the plurality of smart sensors 10 and the CAN bus 8. The first pressure and temperature sensor 5 constantly uploads temperature data and pressure data to the ECU 9 so that the ECU 9 is able to control the temperature and the pressure within the fuel reservoir 22 according to the received temperature data and pressure data. Even though a single cam-driven pump 21 is used within the pressure pump system 2 of the preferred configuration, the present invention can utilize multiple cam-driven pumps 21 to maximize the efficiency of the pressure pump system 2.

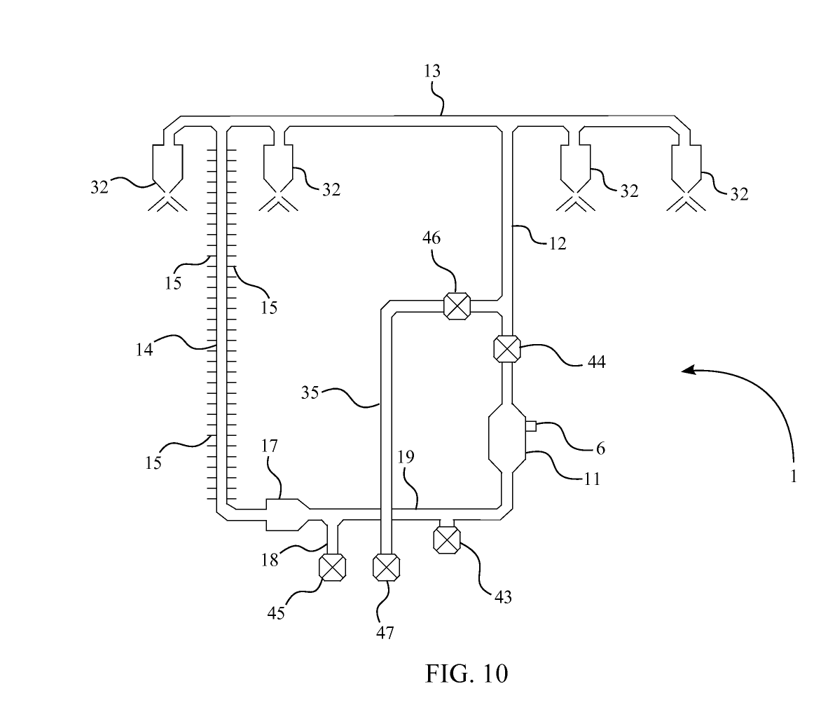

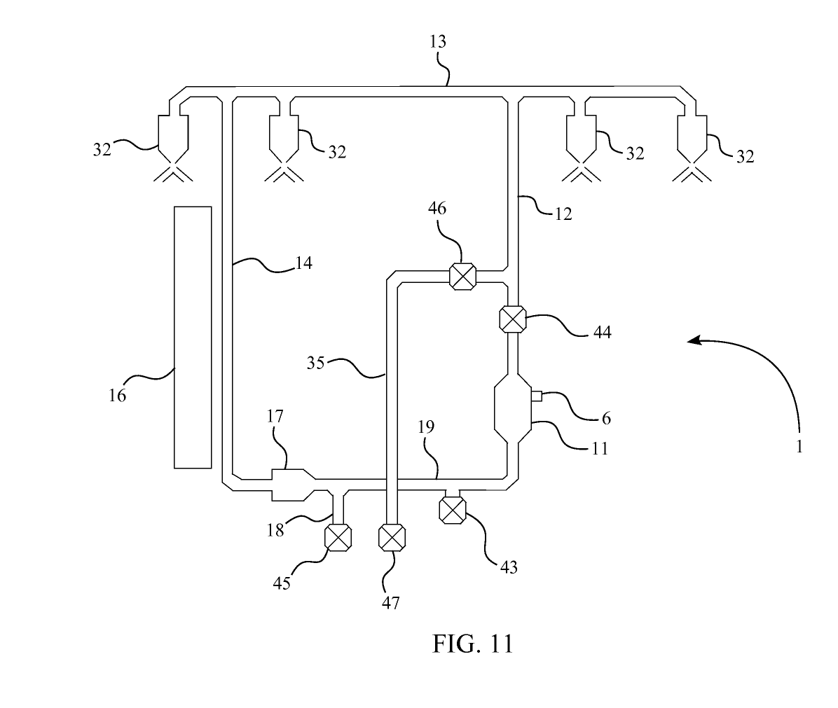

In reference to FIG. 1, FIG. 8, FIG. 10 and FIG. 11, the at least one fuel heating system 1 comprises a heating line 11, a supply line 12, a distributor line 13, a cooling line 14, a flow control injector 17, a drain line 18, and a heated fuel return line 19. The heating line 11 is in serial fluid communication with the supply line 12 through the third one-way valve 44, where the heating line 11 is adjacently positioned to an exhaust manifold. The heating line 11, which heats up the ambient temperature fuel, withdraws heat energy from the exhaust manifold so that the heat energy can be transferred into the ambient temperature fuel through convection. This process allows the present invention to heat up the ambient temperature fuel within the heating line 11. The second pressure and temperature sensor 6 is positioned on the heating line 11 and electronically connected with the ECU 9 through the plurality of smart sensors 10 and the CAN bus 8. The second pressure and temperature sensor 6 constantly uploads temperature data and pressure data to the ECU 9 so that the ECU 9 is able to control the plurality of valves 4 according to the received temperature data and pressure data. The supply line 12 is in parallel fluid communication with each of the plurality of fuel injectors 32 and the cooling line 14 through the distributor line 13. More specifically, the fluid communication of the supply line 12 and the distributor line 13 allows the heated fuel from the heating line 11 to travel into the plurality of fuel injectors 32, where the distributor line 13 evenly supplies heated fuel into the plurality of fuel injectors 32. The plurality of fuel injectors 32 only requires the minimum amount of fuel for their operation within the at least one fuel heating system 1. Any excess heated fuel from the distributor line 13 is then flowed into the cooling line 14. The cooling line 14 reduces the elevated temperature of the heated fuel as the heated fuel travels through the cooling line 14. Since the elevated temperature of heated fuel decreases within the cooling line 14, the elevated pressure within the heated fuel also decreases along with the temperature. In order to cool down the heated fuel, the present invention utilizes two different methods, where one does not precede the other. As for the first method that is shown within FIG. 10, a plurality of cooling fins 15 is exteriorly connected along the cooling line 14, where the plurality of cooling fins 15 functions as a heat sink. As for the second method that is shown within FIG. 11, the cooling line 14 is adjacently positioned with a radiator 16 so that the heated fuel can be cool down. The flow control injector 17 is in serial fluid communication with the cooling line 14 and electronically connected with the ECU 9 through the plurality of smart sensors 10 and the CAN bus 8 so that the flow control injector 17 is able to determine the fuel usage rate of the engine. The flow control injector 17 controls the resulting rise in the heated fuel's temperature and pressure. In other words, the ECU 9 controls the flow control injector 17 so that the flow control injector 17 is able to control the time that the ambient temperature fuel is stationed within the heating line 11. Thus the rate of fuel usage at any engine speed can be held constant by the flow control injector 17. The drain line 18 and the heating line 11 are in junctional fluid communication with the flow control injector 17 through the heated fuel return line 19 so that the drain line 18, the heating line 11, and the heated fuel return line 19 can complete fuel circulation of the at least one fuel heating system 1. Additionally, the in fluid communication in between the at least one fuel heating system 1 and the fuel outlet 24 is completed through the heating line 11, the drain line 18, the heated fuel return line 19, and the second one-way valve 43 for the proper circulation of the ambient temperature fuel.

More specifically, in reference to inline engines, the drain line 18 is in parallel fluid communication with the main fuel rail 31 through the fourth one-way valve 45 as the fourth one-way valve 45 is positioned in between the drain line 18 and the main fuel rail 31. As long as the at least one fuel heating system 1 is activated, the flow control injector 17 is able to continuously pump cool-down fuel from the flow control injector 17 into the heating line 11 through the heated fuel return line 19, where the heated fuel return line 19 is in fluid communication in between the flow control injector 17 and the heating line 11. The configuration of the heating line 11, the supply line 12, the distributor line 13, the cooling line 14, the flow control injector 17, and the heated fuel return line 19 create a complete fuel cycle within the at least one fuel heating system 1. In reference to V-engines, the drain line 18 is in parallel fluid communication with the main fuel rail 31 through the fourth one-way valve 45 as the fourth one-way valve 45 is positioned in between the drain line 18 and the main fuel rail 31. As long as the at least one fuel heating system 1 is activated, the flow control injector 17 is able to continuously pump cool-down fuel from the flow control injector 17 into the heating line 11 through the heated fuel return line 19. The configuration of the heating line 11, the supply line 12, the distributor line 13, the cooling line 14, the flow control injector 17, and the heated fuel return line 19 create a complete fuel cycle within the at least one fuel heating system 1.

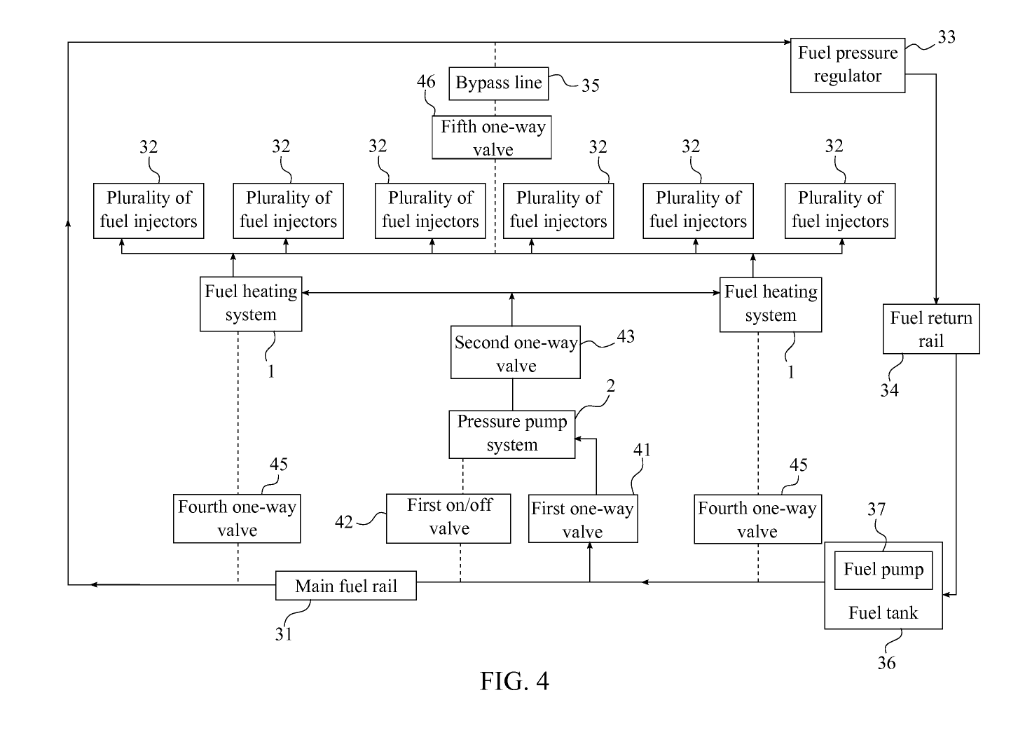

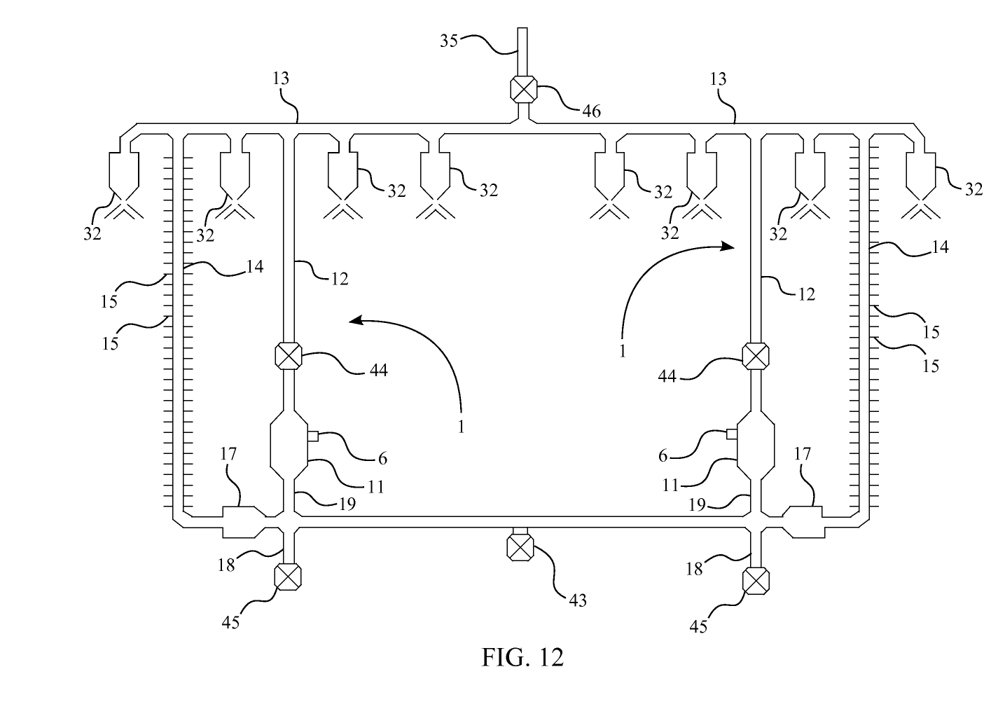

Depending on different engine configurations, the bypass line 35 can be in fluid communication with two different configurations. In reference to a first configuration of the bypass line 35 that is shown within FIG. 1 and FIG. 10, the bypass line 35 is in fluid communication with the supply line 12 and the main fuel rail 31 through the fifth one-way valve 46 and the second on/off valve 47, where the fifth one-way valve 46 and the second on/off valve 47 are in serial fluid communication along the bypass line 35. Additionally, the fifth one-way valve 46 is in serial fluid communication in between the supply line 12 and the bypass line 35, and the second on/off valve 47 is in serial fluid communication in between the main fuel rail 31 and the bypass line 35. In reference to a second configuration of the bypass line 35 that is shown within FIG. 4 and FIG. 12, the bypass line 35 is in fluid communication in between the distributor line 13 and the main fuel rail 31 through the fifth one-way valve 46, where the fifth one-way valve 46 is in serial fluid communication along the bypass line 35.

At the engine start up, the first one-way valve 41, the second one-way valve 43, and the third one-way valve 44 are in an opened position while the first on/off valve 42, fourth one-way valve 45, and the fifth one-way valve 46 are in a closed position. In other words, the first one-way valve 41, the second one-way valve 43, and the third one-way valve 44 function as normally open one-way valves while the fourth one-way valve 45 and the fifth one-way valve 46 function as normally close one-way valves. If the bypass line 35 includes the second on/off valve 47, the second on/off valve 47 is also in the closed position. In reference to FIG. 1 and FIG. 4, the ambient temperature fuel from the fuel tank 36 is supplied into the fuel reservoir 22 through the main fuel rail 31, where the ambient temperature fuel travels through the first one-way valve 41 at a standard pressure. Since the ambient temperate fuel's temperature and pressure increases are desirable, the cam-driven pump 21 increases the pressure of the ambient temperature fuel as needed, within the fuel reservoir 22. More specifically, cam-driven pump 21 draws ambient temperature fuel from the main fuel rail 31 into the fuel reservoir 22 during an intake stroke of the cam-driven pump 21 while a compression stroke of the cam-driven pump 21 increases the standard pressure of the ambient temperature fuel. As a result of the increasing pressure, the temperature of the ambient temperature fuel also increases.

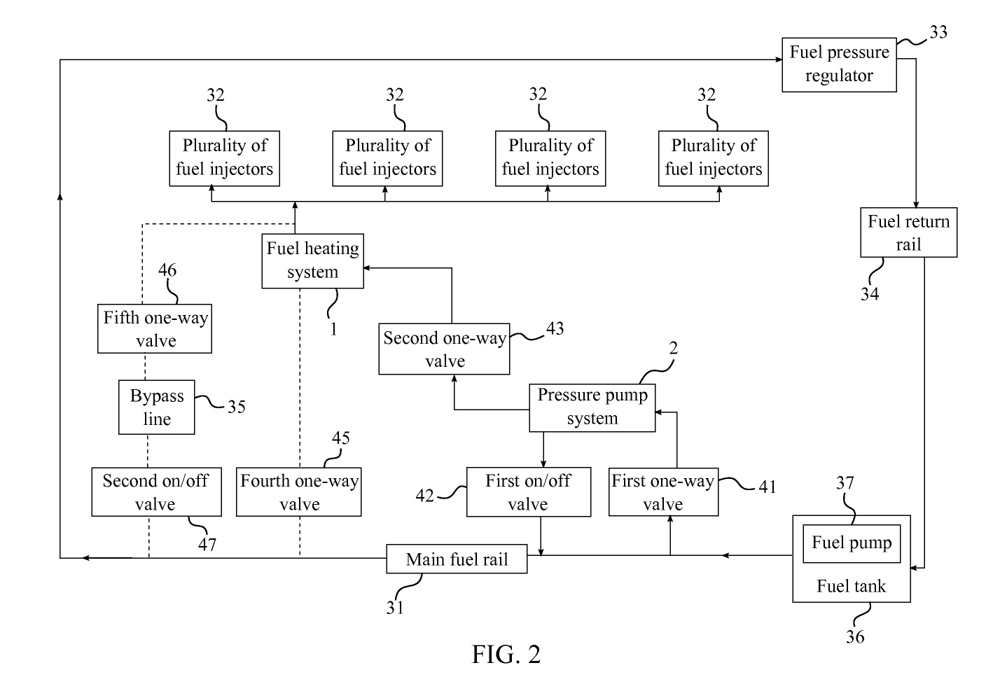

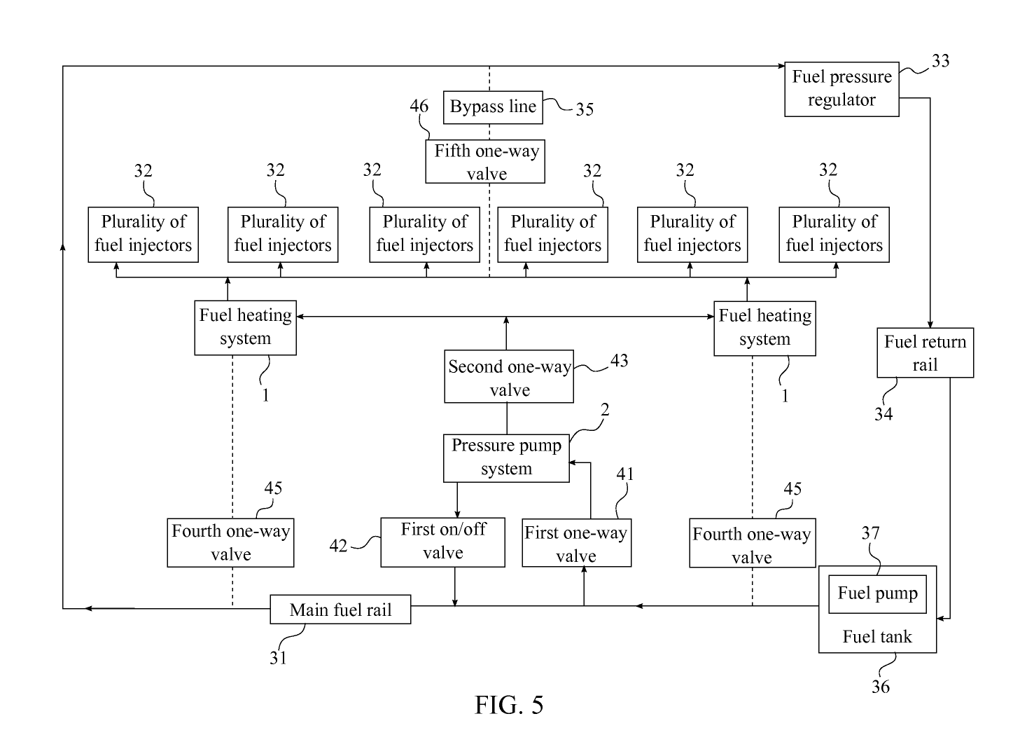

Since the cam-driven pump 21 is operated in relation to the cam shaft, the intake stroke and the compression stroke take place every revolution of the engine in relation to the synchronized firing order of the engine's cylinders. For example, every time the cam shaft opens intake valves of the engine, the intake stroke of the cam-driven pump 21 draws fuel into the fuel reservoir 22 in order to compensate for the combusted fuel. This process allows the cam-driven pump 21 to constantly draw the correct amount of fuel from the main fuel rail 31. When the cam shaft opens exhaust valves of the engine, the compression stroke of the cam-driven pump 21 does not draw any fuel into the fuel reservoir 22 so that the fuel volume within the fuel reservoir 22 can be maintained without compromising the pressure pump system 2. The ECU 9 is programmed to maintain a higher positive pressure at the input of the second one-way valve 43. This positive pressure is equal to the pressure difference in between the first pressure and temperature sensor 5 and the second pressure and temperature sensor 6. Since the ECU 9 constantly receives the pressure data and the temperature data through the first pressure and temperature sensor 5 and the second pressure and temperature sensor 6, the ECU 9 is able to calculate the pressure difference through the received pressure data. In reference to FIG. 2 and FIG. 5, the ECU 9 opens or closes the first on/off valve 42 during the compression stroke as necessary in order to maintain the positive pressure difference while releasing any excess pressure from the fuel reservoir 22 into the main fuel rail 31.

In reference to FIG. 1 and FIG. 4, the pressurized fuel from the fuel reservoir 22 is flowed into the heating line 11 so that the temperature of the pressurized fuel can be increased through the exhaust manifold. Since the pressurized temperature fuel from the pressure pump system 2 is heated by passing through the heating line 11, the at least one fuel heating system 1 takes a period of time to heat the pressurized fuel. In order to compensate for the period of time, the amount of pressurized fuel that passes through the heating line 11 is controlled by the ECU 9. The heated fuel from the heating line 11 is then supplied to the supply line 12 so that the heated fuel is able to flow into the plurality of fuel injectors 32 through the distributor line 13. Since the plurality of fuel injectors 32 is electronically connected with the ECU 9, the ECU 9 determines the fuel usage rate of the plurality of fuel injectors 32. Once the engine's fuel usage rate is established with regard to maintaining a desired fuel temperature and pressure, the plurality of fuel injectors 32 uses the efficient amount of heated fuel and the excess heated fuel within the distributor line 13 flows into the cooling line 14. Then cooling line 14 aborts the expansion of the heated fuel and decreases the temperature of the heated fuel. Since the cooling line 14 is in fluid communication with the flow control injector 17, and the flow control injector 17 is electronically connected with the ECU 9, the ECU 9 is able to determine the cooling rate of the heated fuel with the cooling line 14. The somewhat cooler fuel is then returned back to the heating line 11 through the flow control injector 17 and supplemented by the pressurized fuel from the pressure pump system 2. This continuous circulation process takes place within the present invention as long as the engine is running so that the plurality of fuel injectors 32 is able to inject heated fuel into the combustion chambers.

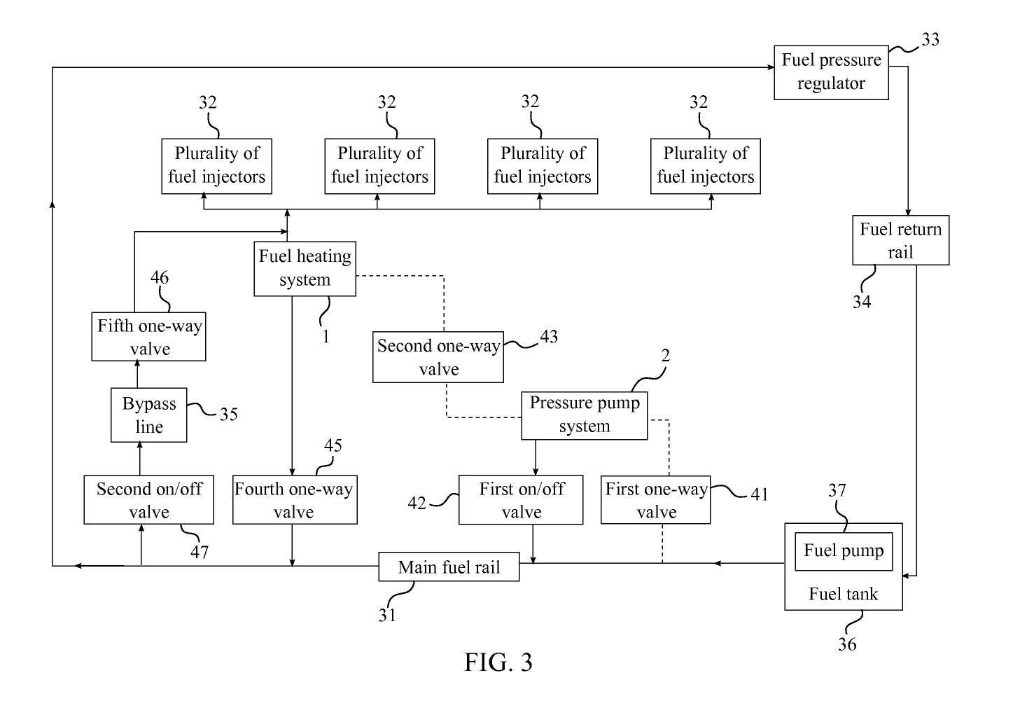

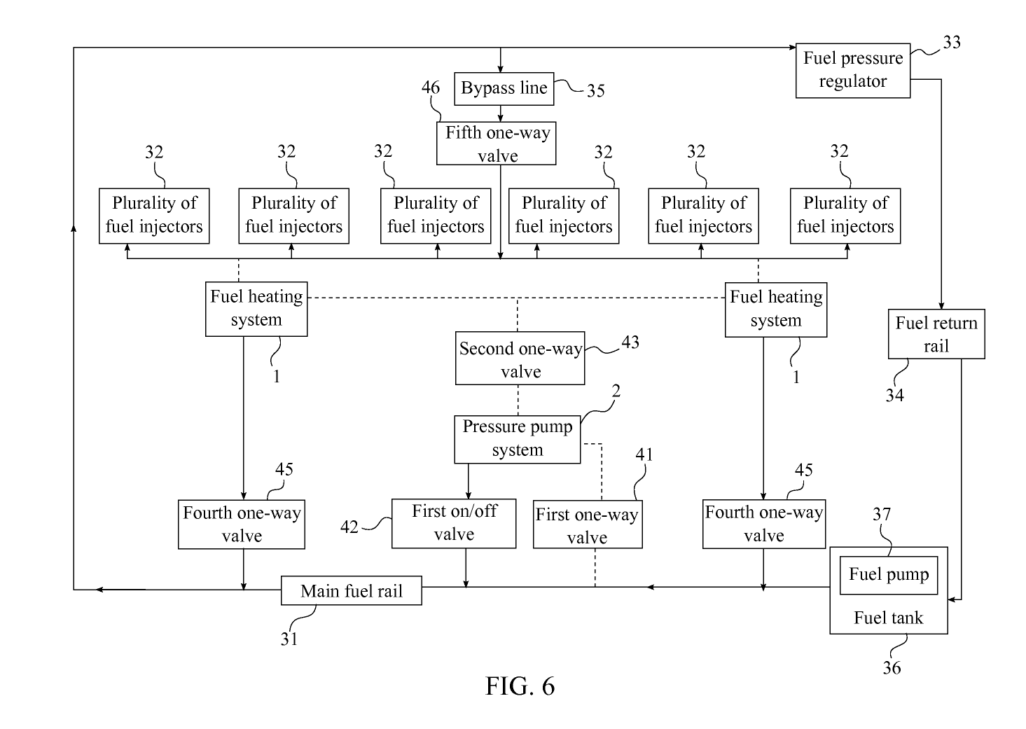

In reference to FIG. 3 and FIG. 6, the at least one fuel heating system 1 and the pressure pump system 2 are designed as completely closed systems. When the at least one fuel heating system 1 and the pressure pump system 2 need to be isolated from the fuel injection system 3 due to malfunctions or routine maintenance, the isolation process can be carried out through the ECU 9. The ECU 9 simultaneously turns the first one-way valve 41, the second one-way valve 43, and the third one-way valve 44 into the closed position while the first on/off valve 42, fourth one-way valve 45, and the fifth one-way valve 46 are simultaneously turned into the opened position. If the bypass line 35 includes the second on/off valve 47, the second on/off valve 47 is also turned into the opened position.

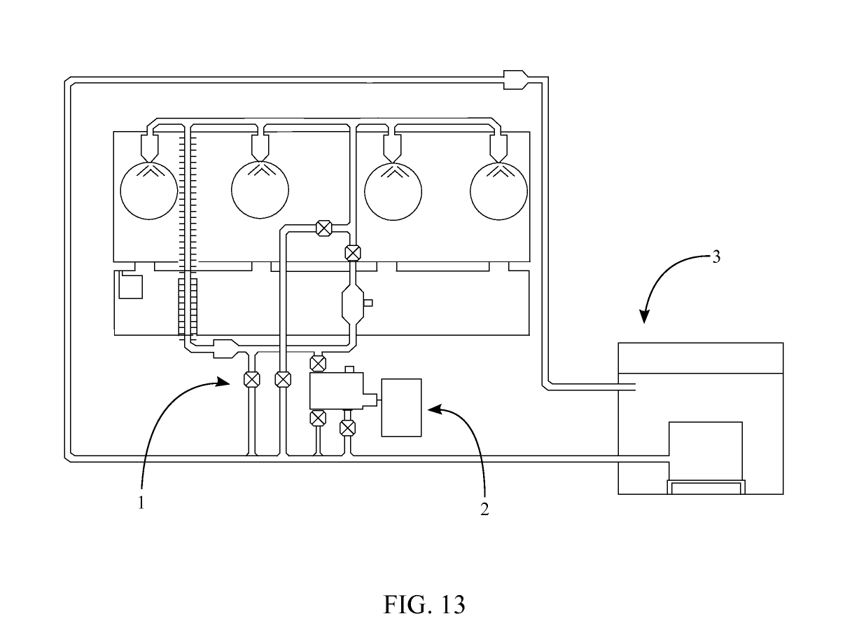

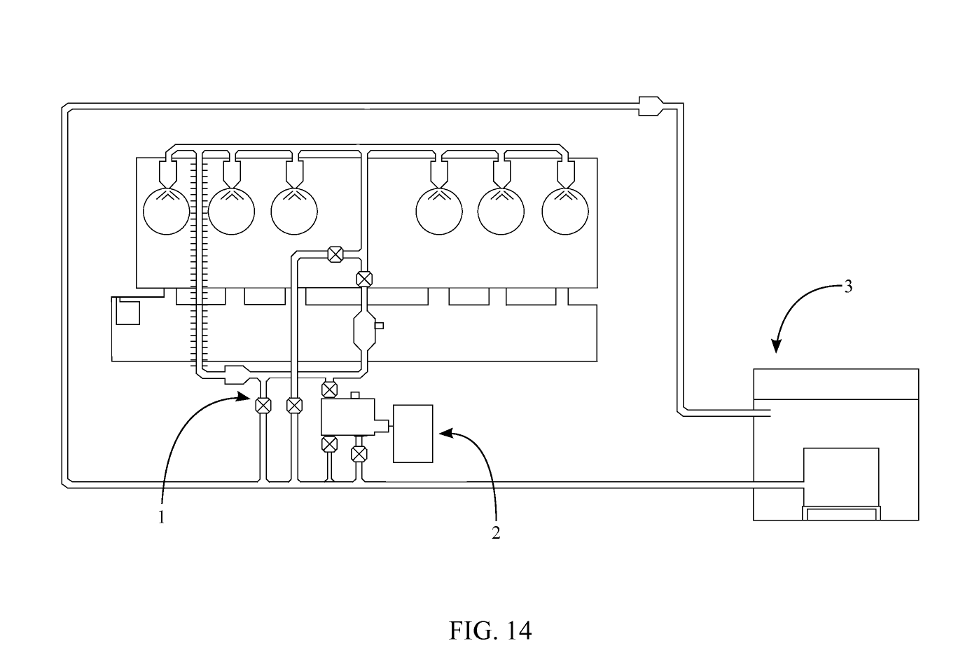

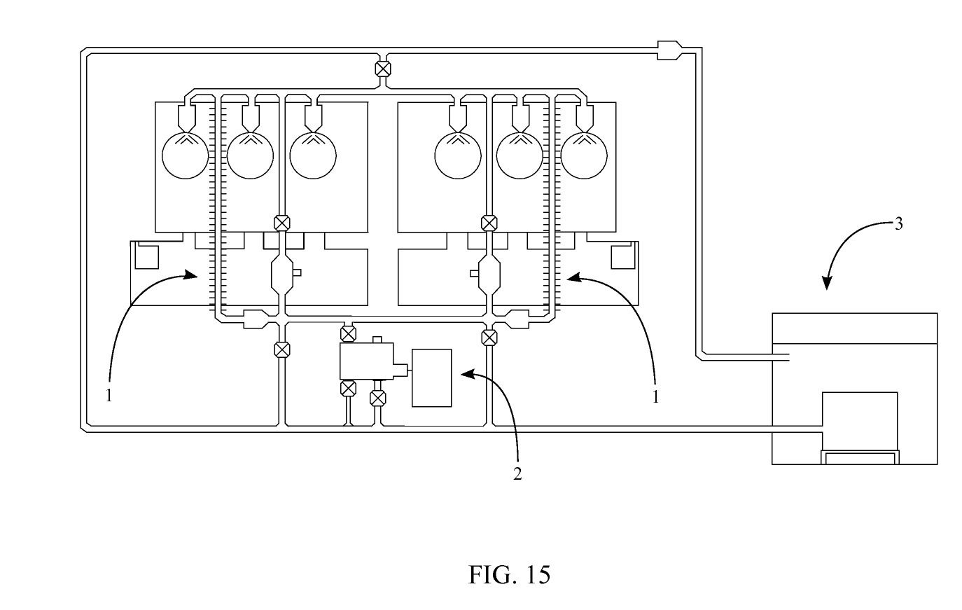

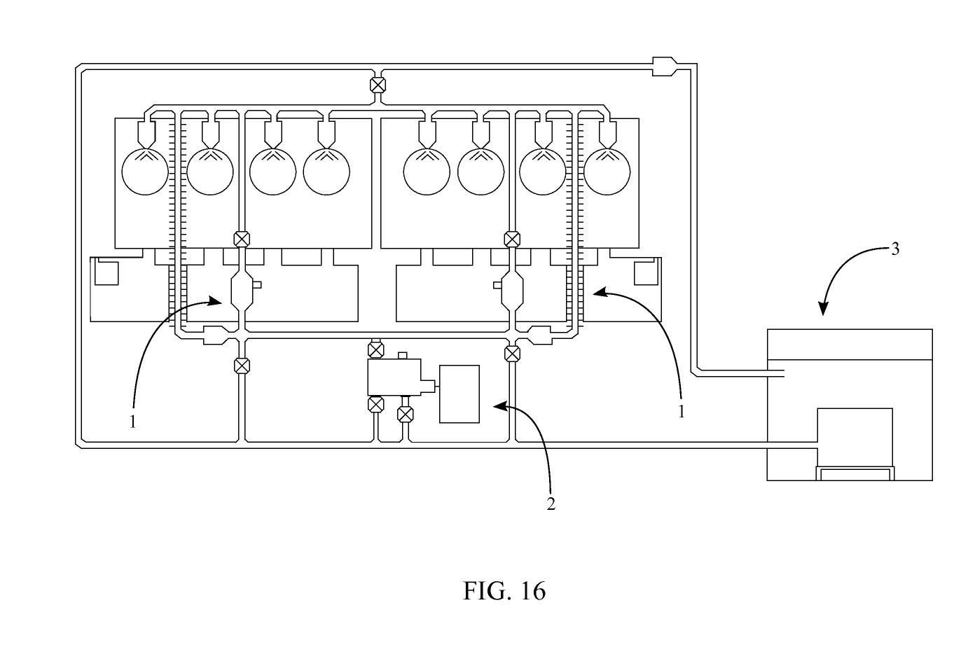

More specifically, the first one-way valve 41 stops the flow of ambient temperature fuel from the main fuel rail 31 into the pressure pump system 2. The second one-way valve 43 stops the flow of pressurized fuel from the pressure pump system 2 into the at least one fuel heating system 1. The third one-way valve 44 stops the flow of heated fuel from the heating line 11 into the supply line 12. The cam-driven pump 21 is also shutdown or disengaged along with the first one-way valve 41, the second one-way valve 43, and the third one-way valve 44. The opening of the first on/off valve 42 allows the pressurized fuel within the pressure pump system 2 to drain into the main fuel rail 31 through the first on/off valve 42. The small amount of heated fuel trapped within the heating line 11 then flows backward so that the heated fuel can exit from the at least one fuel heating system 1 through the fourth one-way valve 45 and the drain line 18. In reference to the first configuration of the bypass line 35 that is shown within FIG. 1, the bypass line 35 supplies ambient temperature fuel into the plurality of fuel injectors 32 through the fifth one-way valve 46 and second on/off valve 47. In reference to the second configuration of the bypass line 35 that is shown within FIG. 6, the bypass line 35 supplies ambient temperature fuel into the plurality of fuel injectors 32 through the fifth one-way valve 46. The flow control injector 17 continuously circulates heated fuel into the main fuel rail 31 through the drain line 18 and control the pressure until the fuel temperature returns to the ambient temperature and the standard pressure. The ECU 9 commands the flow control injector 17 as the ECU 9 receives continuous data from the second pressure and temperature sensor 6. Once the heated fuel from the plurality of fuel injectors 32 reach the standard pressure and the ambient temperature, the flow control injector 17 is automatically shut off by the ECU 9. If the present invention is unable to function during the start-up process of the engine, the ECU 9 automatically isolates the present invention as a safety measure. In reference to FIG. 13-FIG. 16, the present invention can be implemented with any type engine regardless the number of cylinders. For example, inline engines require at least one fuel heating system 1 while the V-engines require at least two fuel heating systems 1. In other words, since the present invention is associated with the exhaust manifold of the engine, each exhaust manifold of the engine requires at least one fuel heating system 1 for the efficient functionality of the engine.

Although the invention has been explained in relation to its preferred embodiment, it is to be understood that many other possible modifications and variations can be made without departing from the spirit and scope of the invention as hereinafter claimed.

What is claimed is:

1. A system to lower fuel viscosity prior to fuel combustion comprises:
at least one fuel heating system;
a pressure pump system;
a fuel injection system;
the at least one fuel heating system comprises, a heating line, a supply line, a distributor line, a cooling line, a flow control injector, a drain line, and a heated fuel return line;
the fuel injection system comprises a plurality of fuel injectors, a main fuel rail, a fuel pressure regulator, a fuel return rail, and a bypass line;
the pressure pump system being in parallel fluid communication with the main fuel rail;
the at least one fuel heating system being in serial fluid communication with the pressure pump system;
the plurality of fuel injectors being in serial fluid communication with the at least one fuel heating system; and
the at least one fuel heating system being in parallel fluid communication with the main fuel rail.

2. The system to lower fuel viscosity prior to fuel combustion as claimed in claim 1 comprises:
the heating line being in serial fluid communication with the supply line;
the supply line being in parallel fluid communication with each of the plurality of fuel injectors and the cooling line through the distributor line;
the flow control injector being in serial fluid communication with the cooling line;
the drain line and the heating line being in junctional fluid communication with the flow control injector through the heated fuel return line;
the drain line being in parallel fluid communication with the main fuel rail; and
the main fuel rail being in fluid communication with the fuel return rail through the fuel pressure regulator.

3. The system to lower fuel viscosity prior to fuel combustion as claimed in claim 2, wherein a plurality of cooling fins is exteriorly connected along the cooling line.

4. The system to lower fuel viscosity prior to fuel combustion as claimed in claim 2, wherein the cooling line being adjacently positioned with a radiator.

5. The system to lower fuel viscosity prior to fuel combustion as claimed in claim 1, wherein the heating line being adjacently positioned to an exhaust manifold.

6. The system to lower fuel viscosity prior to fuel combustion as claimed in claim 1 comprises:
the pressure pump system comprises a cam-driven pump and a fuel reservoir;
the fuel reservoir comprises a fuel inlet, a fuel outlet, and a pres sure-regulating outlet;
the cam-driven pump being in fluid communication with the fuel reservoir;
the fuel inlet, the fuel outlet, and the pressure-regulating outlet being in fluid communication with each other through the fuel reservoir;
the fuel inlet being in fluid communication with the main fuel rail;
the pressure-regulating outlet being in fluid communication with the main fuel rail; and
the fuel outlet being in fluid communication with the at least one fuel heating system in between the heating line and the drain line.

7. The system to lower fuel viscosity prior to fuel combustion as claimed in claim 1, wherein the supply line being in fluid communication with the main fuel rail through the bypass line.

8. The system to lower fuel viscosity prior to fuel combustion as claimed in claim 1, wherein the distributor line being in fluid communication with the main fuel rail through the bypass line.

9. The system to lower fuel viscosity prior to fuel combustion as claimed in claim 1 comprises:
a plurality of valves;
the plurality of valves comprises a first one-way valve, a first on/off valve, a second one-way valve, a third one-way valve, a fourth one-way valve, a fifth one-way valve, and a second on/off valve;
the first one-way valve, the first on/off valve, the second one-way valve, the third one-way valve, the fourth one-way valve, the fifth one-way valve, and the second on/off valve being electronically connected with an engine control unit (ECU) through a plurality of smart sensors and a controller-area network (CAN) bus;
the first one-way valve being in serial fluid communication in between the fuel inlet and the main fuel rail;
the first on/off valve being in serial fluid communication in between the pressure-regulating outlet and the main fuel rail;
the second one-way valve being in serial fluid communication in between the fuel outlet and the at least one fuel heating system;
the third one-way valve being in serial fluid communication in between the heating line and the supply line; and
the fourth one-way valve being in serial fluid communication in between the drain line and the main fuel rail.

10. The system to lower fuel viscosity prior to fuel combustion as claimed in claim 9 comprises:
the fifth one-way valve and the second on/off valve being in serial fluid communication along the bypass line;
the fifth one-way valve being in serial fluid communication in between the supply line and the bypass line; and
the second on/off valve being in serial fluid communication in between the main fuel rail and the bypass line.

11. The system to lower fuel viscosity prior to fuel combustion as claimed in claim 9, wherein the fifth one-way valve being in serial fluid communication in between the distributor line and the main fuel rail.

12. The system to lower fuel viscosity prior to fuel combustion as claimed in claim 1 comprises:
a first pressure and temperature sensor;
a second pressure and temperature sensor;
the first pressure and temperature sensor being positioned on the fuel reservoir;
the first pressure and temperature sensor being electronically connected with an engine control unit (ECU) through a plurality of smart sensors and a controller-area network (CAN) bus;
the second pressure and temperature sensor being positioned on the heating line;
the second pressure and temperature sensor being electronically connected with the ECU through the plurality of smart sensors and the CAN bus;
the plurality of fuel injectors being electronically connected with the ECU through the plurality of smart sensors and the CAN bus;
the flow control injector being electronically connected with the ECU through the plurality of smart sensors and the CAN bus; and
the fuel pressure regulator being electronically connected with the ECU through the plurality of smart sensors and the CAN bus.

13. A system to lower fuel viscosity prior to fuel combustion comprises:
at least one fuel heating system;
a pressure pump system;
a fuel injection system;
the at least one fuel heating system comprises, a heating line, a supply line, a distributor line, a cooling line, a flow control injector, a drain line, and a heated fuel return line;
the fuel injection system comprises a plurality of fuel injectors, a main fuel rail, a fuel pressure regulator, a fuel return rail, and a bypass line;
the heating line being in serial fluid communication with the supply line;
the heating line being adjacently positioned to an exhaust manifold;
the supply line being in parallel fluid communication with each of the plurality of fuel injectors and the cooling line through the distributor line;
the flow control injector being in serial fluid communication with the cooling line;
the drain line and the heating line being in junctional fluid communication with the flow control injector through the heated fuel return line;
the drain line being in parallel fluid communication with the main fuel rail;
the pressure pump system being in parallel fluid communication with the main fuel rail;
the at least one fuel heating system being in serial fluid communication with the pressure pump system;
the plurality of fuel injectors being in serial fluid communication with the at least one fuel heating system;
the at least one fuel heating system being in parallel fluid communication with the main fuel rail; and
the main fuel rail being in fluid communication with the fuel return rail through the fuel pressure regulator.

14. The system to lower fuel viscosity prior to fuel combustion as claimed in claim 13 comprises:
the pressure pump system comprises a cam-driven pump and a fuel reservoir;
the fuel reservoir comprises a fuel inlet, a fuel outlet, and a pres sure-regulating outlet;
the cam-driven pump being in fluid communication with the fuel reservoir;
the fuel inlet, the fuel outlet, and the pressure-regulating outlet being in fluid communication with each other through the fuel reservoir;
the fuel inlet being in fluid communication with the main fuel rail;
the pressure-regulating outlet being in fluid communication with the main fuel rail; and
the fuel outlet being in fluid communication with the at least one fuel heating system in between the heating line and the drain line.

15. The system to lower fuel viscosity prior to fuel combustion as claimed in claim 13, wherein the supply line being in fluid communication with the main fuel rail through the bypass line.

16. The system to lower fuel viscosity prior to fuel combustion as claimed in claim 13, wherein the distributor line being in fluid communication with the main fuel rail through the bypass line.

17. The system to lower fuel viscosity prior to fuel combustion as claimed in claim 13 comprises:
a plurality of valves;
the plurality of valves comprises a first one-way valve, a first on/off valve, a second one-way valve, a third one-way valve, a fourth one-way valve, a fifth one-way valve, and a second on/off valve;
the first one-way valve, the first on/off valve, the second one-way valve, the third one-way valve, the fourth one-way valve, the fifth one-way valve, and the second on/off valve being electronically connected with an engine control unit (ECU) through a plurality of smart sensors and a controller-area network (CAN) bus;
the first one-way valve being in serial fluid communication in between the fuel inlet and the main fuel rail;
the first on/off valve being in serial fluid communication in between the pressure-regulating outlet and the main fuel rail;
the second one-way valve being in serial fluid communication in between the fuel outlet and the at least one fuel heating system;
the third one-way valve being in serial fluid communication in between the heating line and the supply line; and
the fourth one-way valve being in serial fluid communication in between the drain line and the main fuel rail.

18. The system to lower fuel viscosity prior to fuel combustion as claimed in claim 17 comprises:
the fifth one-way valve and the second on/off valve being in serial fluid communication along the bypass line;
the fifth one-way valve being in serial fluid communication in between the supply line and the bypass line; and
the second on/off valve being in serial fluid communication in between the main fuel rail and the bypass line.

19. The system to lower fuel viscosity prior to fuel combustion as claimed in claim 17, wherein the fifth one-way valve being in serial fluid communication in between the distributor line and the main fuel rail.

20. The system to lower fuel viscosity prior to fuel combustion as claimed in claim 13 comprises:
a first pressure and temperature sensor;
a second pressure and temperature sensor;
the first pressure and temperature sensor being positioned on the fuel reservoir;
the first pressure and temperature sensor being electronically connected with an engine control unit (ECU) through a plurality of smart sensors and a controller-area network (CAN) bus;
the second pressure and temperature sensor being positioned on the heating line;
the second pressure and temperature sensor being electronically connected with the ECU through the plurality of smart sensors and the CAN bus;
the plurality of fuel injectors being electronically connected with the ECU through the plurality of smart sensors and the CAN bus;
the flow control injector being electronically connected with the ECU through the plurality of smart sensors and the CAN bus; and
the fuel pressure regulator being electronically connected with the ECU through the plurality of smart sensors and the CAN bus.
